(19) United States
(12) Patent Application Publication
(10) Pub. No.: US 2014/0297597 A1
(43) Pub. Date: Oct. 2, 2014

(54) COMPUTER SYSTEM AND MANAGEMENT METHOD FOR THE SAME

(71) Applicants: Keisuke Matsubara, Yokohama (JP); Masaru Iwashita, Yokohama (JP)

(72) Inventors: Keisuke Matsubara, Yokohama (JP); Masaru Iwashita, Yokohama (JP)

(73) Assignee: HITACHI, LTD., Tokyo (JP)

(21) Appl. No.: 13/783,483

(22) PCT Filed: Sep. 27, 2010
(86) PCT No.: PCT/JP2010/005803

§ 371 Date: Apr. 2, 2014

(51) Int. Cl. G06F 11/14

(52) U.S. Cl. CPC G06F 11/1458
USPC 707/681

(57) ABSTRACT

A computer system in which restoration of a system state of the computer system can be carried out efficiently and a management method for the same are proposed.

In a computer system having a host server which provides a computer system made up of one or plural computers to a client, and a management server which instructs the host server to construct the computer system or to restore a system state of the computer system that already exists in response to a request from a user, the host server records a content of change in the state from a predetermined time point for each computer, and for at least one of the computers constituting the computer system, the host server selects an optimum restoration method for the computer from plural restoration methods, based on the recorded content of change in the state from the predetermined time point for each computer in response to the instruction from the management server, and restores the state of the computer to the state at the predetermined time point by the selected restoration method.

### TECHNICAL FIELD

The present invention relates to a computer system and a management method for the same and is suitably applied particularly to a computer system including a host server which provides a computer system made up of one or plural computers to a client.

### BACKGROUND ART

Recently, the use of a computer system is widespread and common in society. Also, the computer system is becoming increasingly complicated because of the increase in constituent computers and items that are set. Therefore, managing the computer system takes increased time and effort and reduction in this time and effort is demanded.

Under such circumstances, a method in which one or plural computers that are virtual (hereinafter referred to as virtual machines) are created on a server, thus constructing a computer system that is virtual (hereinafter referred to as a virtual machine system) with the one or plural virtual machines, is recently proposed. With this method, the time and effort required for the management of physical computer resources can be reduced.

Meanwhile, in the computer system to which this virtualization technique is applied, in some cases, the state of the virtual machine system may need to be restored to the state at a predetermined time point that is saved in advance. These cases include, for example, a case where when trouble occurs in the virtual machine system, the state of the virtual machine system is restored to the state before the occurrence of the trouble, and a case where in the development of an application, the state of the virtual machine system at the time point when a testing environment is constructed is saved and the testing environment is restored when re-testing is executed, and the like.

As a method for reducing the time and effort to manage the computer system, for example, Patent Literature 1 discloses a method in which a change from the state of a computer at the time of shipment from the plant, such as update of software in the computer, is recorded in a storage device of the computer, and when trouble occurs in the computer, the computer is returned to the state at the time of shipment from the plant and then the recorded content of change are automatically applied. Also, Patent Literature 2 discloses a method in which a duplicate of a virtual machine constituting a virtual machine system is made to stand by, and when trouble occurs, the connection destination is switched to the standby virtual machine.

### CITATION LIST

### Patent Literature

PTL 1: JP-A-2007-304768
PTL 2: JP-A-2010-033404

### SUMMARY OF INVENTION

### Technical Problem

By the way, according to the method disclosed in this Patent Literature 1, there is a problem that the restoration of the system state takes a long time when the content of change is large, though the restoration can be carried out in a short time when the content of change is small. Meanwhile, according to the method disclosed in Patent Literature 2, there is a problem that twice the computer resources are required even when the content of change is small, though the system state can be restored to the state before the occurrence of trouble in a short time irrespective of the content of change. In this way, according to the methods for restoring the system state of the computer system that are conventionally proposed, there is a problem that the restoration of the system state of the computer system cannot be carried out efficiently.

The present invention is made in view of the foregoing points and is to propose a computer system in which the restoration of the system state of the computer system can be carried out efficiently and a management method for the same.

### Solution to Problem

As a solution, according to the invention, a computer system is provided with a host server which provides a computer system made up of one or plural computers to a client, and a management server which instructs the host server to construct the computer system or to restore a system state of the computer system that already exists, in response to a request from a user. The host server records a content of change in the state from a predetermined time point for each of the computers. For at least one of the computers constituting the computer system, the host server selects an optimum restoration method for the computer from plural restoration methods, based on the recorded content of change in the state from the predetermined time point for each of the computers in response to the instruction from the management server, and restores the state of the computer to the state at the predetermined time point by the restoration method that is selected.

Also, according to the invention, a management method for a computer system including a host server which provides a computer system made up of one or plural computers to a client and a management server which instructs the host server to construct the computer system or to restore a system state of the computer system that already exists in response to a request from a user, includes a first step in which the host server records a content of change in the state from a predetermined time point for each of the virtual machines, and a second step in which for at least one of the computers constituting the computer system, the host server selects an optimum restoration method for the virtual machine from plural restoration methods, based on the recorded content of change in the state from the predetermined time point for each of the computers in response to the instruction from the management server, and restores the state of the computer to the state at the predetermined time point by the restoration method that is selected.

### Advantageous Effects of Invention

According to the invention, an appropriate restoration method corresponding to the content of change can be selected and therefore the restoration of the system state of the computer system can be carried out efficiently.

### BRIEF DESCRIPTION OF DRAWINGS

FIG. 1 It is a block diagram showing the overall configuration of a computer system according the present embodiment.

FIG. 2 It is a conceptual view showing the configuration of a system configuration information management table.

FIG. 3 It is a conceptual view showing the configuration of role-specific setting information management table.

FIG. 4 It is a conceptual view showing the configuration of a virtual machine configuration information management table.

FIG. 5 It is a conceptual view showing the configuration of a duplicate virtual machine correspondence information management table.

FIG. 6 It is a conceptual view showing the configuration of a change content record information management table.

FIG. 7 It is a schematic view schematically showing an example of configuration of a system construction screen.

FIG. 8 It is a schematic view schematically showing an example of configuration of a system restoration screen.

FIG. 9 It is a flowchart showing processing procedures of virtual machine system construction processing.

FIG. 10 It is a flowchart showing processing procedures of system state saving processing.

FIG. 11 It is a flowchart showing processing procedures of system state change record processing.

FIG. 12 It is a flowchart showing processing procedures of virtual machine system restoration processing.

FIG. 13 It is a flowchart showing processing procedures of system restoration processing.

FIG. 14 It is a flowchart showing processing procedures of restoration method selection processing.

FIG. 15 It is a flowchart showing processing procedures of system state restoration processing.

### DESCRIPTION OF EMBODIMENTS

Hereinafter, an embodiment of the invention will be described in detail with reference to the drawings.

### (1) Configuration of Computer System

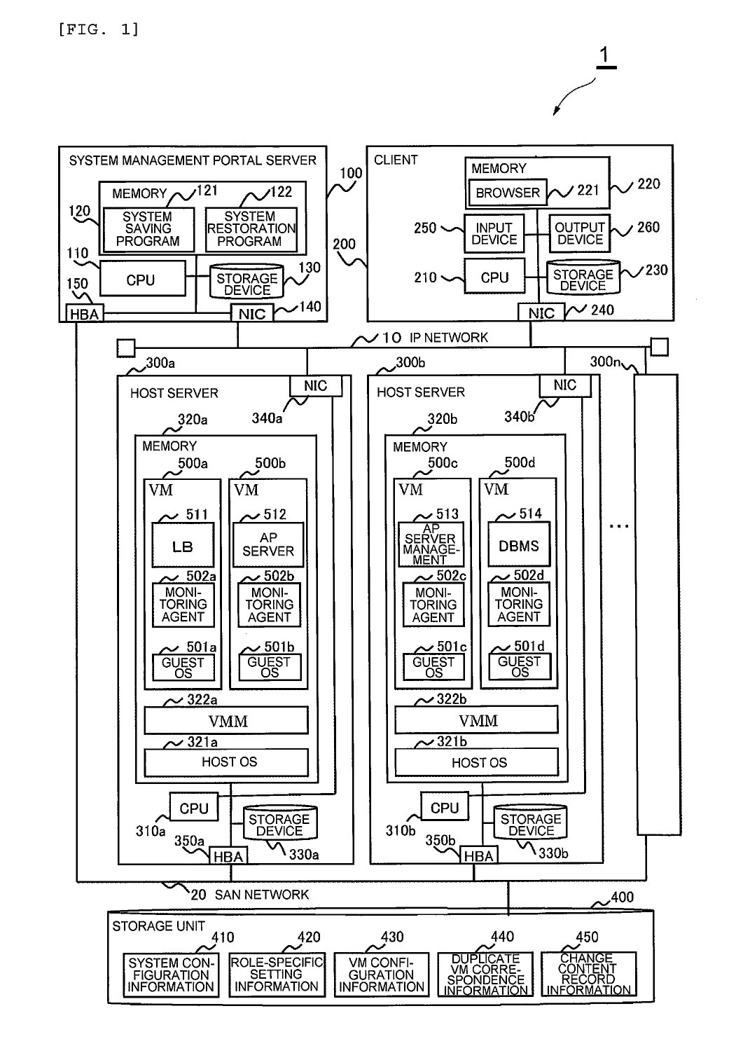

In FIG. 1, 1 represents a computer system according to this embodiment as a whole. This computer system includes a system management portal server 100, a client 200, plural host servers 300a, 300b and a storage unit 400.

The system management portal server 100, the client 200 and host servers 300 are connected to each other in a way that enables communication via an IP network 10 such as LAN (Local Area Network), WAN (Wide Area Network) or the internet. Also, the system management portal server 100 and the host servers 300 are each connected to the storage unit 400 in a way that enables communication via a SAN (Storage Area Network) 20.

The system management portal server 100 is a server which manages the entire computer system 1 and includes a CPU 110, a memory 120, a storage device 130, a host bus adapter (HBA) 150 and NIC (Network Interface Card) 140.

The CPU 110 is a processor in charge of operation control of the entire system management portal server 100. The memory 120 is mainly used to store various kinds of software that are read out from the storage device 130 and various kinds of information, and is also used as a work memory of the CPU 110. Also a system saving program 121 and a system restoration program 122, which will be described later, are stored and held in this memory 120. As the CPU 110 executes software that is read out into the memory 120, a predetermined function is realized.

The storage device 130 is made up of, for example, a semiconductor recording medium such as SSD (Solid State Disk), or a magnetic recording medium or magneto-optical disk such as hard disk, and is used to store software and various data or the like.

The NIC 140 is an adapter to connect the system management portal server 100 to the IP network 10. Also, the host bus adapter 150 is an adapter to connect the system management portal server 100 to the SAN network 20.

The client 200 is a computer device which executes user operations and is made up of a general-purpose personal computer or server device or the like. This client 200 includes a CPU 210, a memory 220, a storage device 230, an input device 250, an output device 260 and a NICC 240.

The CPU 210 is a processor in charge of operation control of the entire client 200. Also, the memory 220 is mainly used to store various kinds of software that are read out from the storage device 230 and various kinds of information, and is also used as a work memory of the CPU 210. As the CPU 210 executes software that is read out into the memory 220, a predetermined function is realized.

Also, a browser 221 is stored in the memory 220. The browser 221 is general application software that visually displays a web content on the internet in a predetermined format. The browser 221 communicates with the system management portal server 100 using a communication protocol that is used for transmission and reception of a web content such as HTTP (Hyper Text Transfer Protocol), and causes the output device 260 to display a text or image obtained through the communication, in a predetermined format.

The storage device 230 is made up of, for example, a disk drive or magneto-optical disk drive or the like and is used to store and hold software such as OS (Operating System) and application programs.

The input device 250 is made up of, for example, a keyboard switch and pointing device. The output device 260 is made up of a display device such as display. Also, the NIC 240 is an adapter to connect the client 200 to the IP network 10. Also, the client 100 may include plural NICs 240.

The host server 300 (300a, 300b, is a computer which executes application software or the like to provide a necessary service for user operations, and includes a CPU 310 (310a, 310b, . . . ), a memory 320 (320a, 320b, . . . ), a storage device 330 (330a, 330b, . . . ), a NIC 340 (340a, 340b, . . . ) and a host bus adapter 350 (350a, 350b, . . . ).

The CPU 310 is a processor in charge of operation control of that entire host server 300. Also, the memory 320 is mainly used to store various kinds of software including a host OS 321 (321a, 321b, . . . ) that are read out from the storage device 330 and various kinds of information, and is also used as a work memory of the CPU 310. As the CPU 310 executes the various kinds of software stored in the memory 320, a predetermined function is realized.

The storage device 330 is made up of, for example, a disk drive or magneto-optical disk drive or the like and is used to store and hold software or the like. The NIC 340 is an adapter to connect the host server 300 to the IP network 10. Also, the host bus adapter 350 is an adapter to connect the host server 300 to the SAN network 20. The host server 300 may include plural NICs 340 and host bus adapters 350.

Here, in the case of this embodiment, a virtual machine management program (Virtual Machine Manager) 322 is stored in the memory 320 of the host server 300. The virtual machine management program 322 is software which converts a physical computer resource of the host server 300 into a virtualized computer resource and allocates this virtual computer resource to each virtual machine. As the CPU 310 executes this virtual machine management program 322, one or plural virtual machines 500 (500a, 500b, 500c, 500d, . . . ) are generated on the memory 320 of the host server 300.

A program according to purposes (hereinafter referred to as a role program) is installed in the virtual machine 500. However, all the virtual machines 500 have the same basic configuration. That is, in each virtual machine 500, a guest OS 501 and a monitoring agent 502, and a role program corresponding to the role of each virtual machine constituting the virtual machine system formed by the one or plural virtual machines 500 are installed.

The guest OS 501 is an OS for the virtual machine 500 in which the guest OS is installed, and is generated by copying the host OS. In each virtual machine 500, programs operate under the guest OS 501. Also, the monitoring agent 502 is software which carries out setting update of the virtual machine 500. The monitoring agent 502 communicates with the system management portal server 100 and executes processing related to the setting update of the virtual machine 500 according to an instruction from the system management portal server 100.

In the case of this embodiment, the role program may be, for example, a load balancer program 511, an application server program 512, an application server management program 513 and a database management program 514 or the like.

The load balancer program 511 is a program which unitarily manages requests transmitted from the client 100 via the IP (Internet Protocol) network 10 and transfers requests to the plural host servers 300. By this load balancer program 511, requests are allocated to the plural host servers 300 so that a specific host server 300 becomes overloaded, and the response speed of each host server 300 is controlled. The virtual machine 500 in which this load balancer program 511 is installed plays the role of a “load balancer” having this function.

The application server program 512 is a program which, on the virtual machine 500 executing application software to carry out operation processing, carries out construction, introduction, execution, maintenance or the like of the application. The virtual machine 500 in which this application server program 512 is installed plays the role of an “application server” having this function.

The application server management program 513 is a program which manages the virtual machine 500 in which the above application server program 512 is installed. For example, the application server management program 513 grasps information of the virtual machine 500 in which the application server program 512 is installed and which is starting up, and executes processing to prevent startup of an unnecessary virtual machine 500. The virtual machine 500 in which this application server management program 513 is installed plays the role of an “application server management server” having this function.

The database management program 514 is software to utilize and manage a database as shared data. For example, when plural users access the same database, the database management program 514 executes processing to prevent inconsistency in data and to keep data constantly in correct state. The virtual machine 500 in which this database management program 514 is installed plays the role of a “database management server” having this function.

By combining one or plural virtual machines 500 in which various role programs as described above are installed, a computer system that is virtual (virtual machine system) having predetermined functions is constructed. Also, the configuration of such a virtual machine system may be created and registered by the user or may be created and registered in advance by a system manager.

The storage unit 400 includes plural physical disks and a controller which controls writing and reading of data to and from these physical disks.

The physical disks include, for example, expensive disks such as SCSI (Small Computer System Interface) disks, or inexpensive disks such as SATA (Serial AT Attachment) disks or optical disks.

Each physical disk is utilized in the RAID (Redundant Arrays of Independent Disks) system by the controller. One or plural physical disks form a RAID group and one or plural logic volumes are set on a storage area provided by physical disks forming one RAID group. Then, data is stored in this logic volume, using a block with a predetermined size as a unit.

### (2) System Saving Function and System Restoration Function in this Computer System

Next, a system saving function and a system restoration function in this computer system 1 will be described.

As a feature of this computer system 1, a system saving function to record the content of change in the state from a predetermined time point of the virtual machine system constituted by the one or plural virtual machines 500 provided by the host server 300, for each virtual machine 500, and a system restoration function to select an optimum restoration method from plural restoration methods for each virtual machine 500, based on the content of change for each virtual machine 500 recorded as described above when restoring the state of the virtual machine system to the state at the predetermined time point, and thus restore the state of each virtual machine 500 to the state at the predetermined time point by the selected restoration method exist.

Here, the “content of change” in the state recorded for each virtual machine 500 includes the file size of a virtual machine image file related to that virtual machine 500, and the type of change to the virtual machine image file. The virtual machine image file refers to a file in which the content of configuration of each virtual machine 500 is stored. The virtual machine management program 322 of the host server 300 duplicates the data of the virtual machine image file to be a master file, and creates the virtual machine 500 using the duplicated virtual machine image file.

Also, the type of change refers to the content of operation to this virtual machine image file. The user updates this virtual machine image file or adds a new virtual machine image file or the like and thus customizes the configuration of the virtual machine 500 to a configuration corresponding to the user's operation. Also, there are “change”, “add”, “delete” and “name change” as types of change.

As a measure to realize the system saving function and the system restoration function as described above, the system saving program 121 and the system restoration program 122 are stored in the memory 120 of the system management portal server 100, and a system configuration information management table 410, a role-specific setting information management table 420, a virtual machine configuration information management table 430, a duplicate virtual machine correspondence information management table 440 and a change content record information management table 450 are stored in the storage unit 400.

The system saving program 121 is a program which constructs a designated virtual machine system on the host server 300 in response to a request from the user and saves the system state of that virtual machine system at that time point. When the user uses the browser 211 of the client 200 to designate a virtual machine system having a desired configuration from predetermined plural types of virtual machine systems and to instruct the construction of the system, a corresponding system construction command is given to the system management portal server 100 from the client 200. The system saving program 121 of the system management portal server 100, receiving this system construction command, instructs the virtual machine management program 322 of the corresponding host server 300 to create a necessary virtual machine 500 and make the virtual machine 500 work. Also, the system saving program 121 instructs the monitoring agent 502 working on each virtual machine 500 that is made to work, to record the content of change when the virtual machine image file (hereinafter referred to as a file when appropriate) of the virtual machine 500 is changed.

Also, the system restoration program 122 is a program which restores the system state of the virtual machine system designated by the user, to the system state at the time point when the system state is saved by the system saving program 121 (specifically, at the time when the virtual machine system is constructed). When the user uses the browser 211 of the client 200 to instruct restoration of a desired virtual machine system, a corresponding system restoration command is given to the system management portal server 100 from the client 200. Then, the system restoration program 122 of the system management portal server 100, receiving this system restoration command, causes the virtual machine management program 322 of the corresponding host server 300 to restore the state of each virtual machine 500 constituting the designated virtual machine system to the state at the time of the construction of the system.

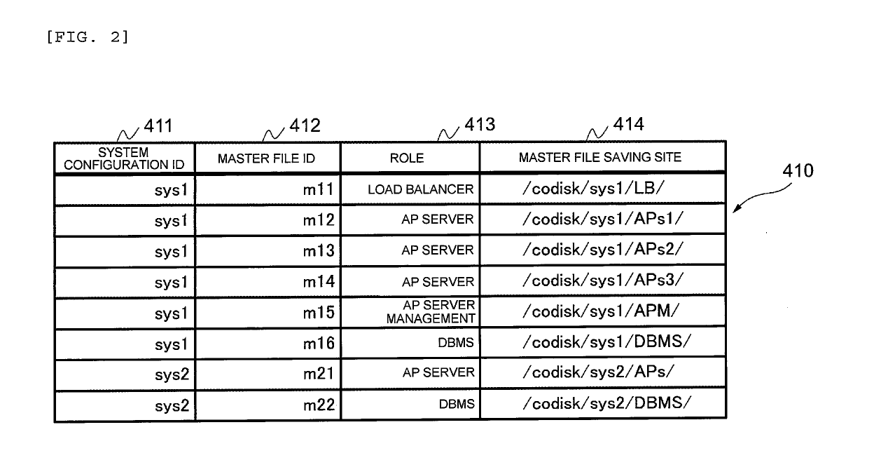

Meanwhile, the system configuration information management table 410 is a table used to manage the configuration of a virtual machine system defined in advance by the user or a system manager or the like, and includes a system configuration ID section 411, a master file ID section 412, a role section 413 and a master file saving site section 414, as shown in FIG. 2.

Then, in the system configuration ID section 411, an identifier given to the corresponding virtual machine system (hereinafter referred to as a system configuration ID) is stored. The user operates the client 200 to designate a desired system configuration ID and thus can construct a virtual machine system with a desired system configuration on the host server 300, from among predefined plural types of virtual machine systems.

For example, if the user designates a virtual machine system with a system configuration ID “sys1” in FIG. 2, one virtual machine 500 playing the role of a load balancer, three virtual machines 500 playing the role of an application server, one virtual machine 500 playing the role of an application server management server, and one virtual machine 500 playing the role of a database management server are created on the host server 300, and these are started up.

In the master file ID section 412, a unique identifier given to a master file of the virtual machine image file of the corresponding virtual machine 500 (hereinafter referred to as a master file ID) is stored. For example, if there are plural virtual machines 500 having the same role as virtual machines 500 constituting the virtual machine system, this identifier is used to identify which master file the virtual machines 500 correspond to.

In the role section 413, the role of the virtual machine 500 in the virtual machine system is stored. This role may be the “load balancer”, “application server”, “application server management server” and “database management server” or the like, as described above. The information stored in this role section 413 is used to acquire setting information of the virtual machine 500 from the role-specific setting information management table 420, which will be described later.

In the master file saving site section 414, information representing a path to the storage site of the corresponding master file (hereinafter referred to as path information) is stored. To duplicate the master file, the path information stored in this master file saving site section 414 is referred to.

Meanwhile, the role-specific setting information management table 420 is a table to manage a restoration method or the like for each of the predetermined roles (“load balancer”, “application server”, “application server management server”) of the virtual machines 500.

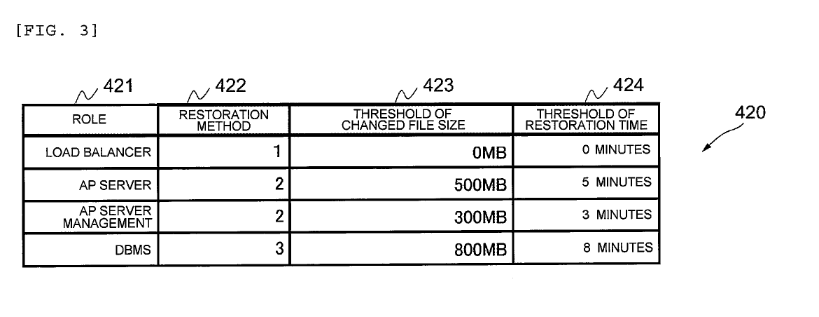

In the case of this embodiment, the default restoration method for the virtual machine 500 is prescribed in advance for each role of that virtual machine 500 and the content of prescription is stored in the role-specific setting information management table 420. This role-specific setting information management table 420 includes a role section 421, a restoration method section 422, a changed file size threshold section 423 and a restoration time threshold section 424, as shown in FIG. 3.

Then, in the role section 421, the predetermined role of the virtual machine 500 is stored. In the restoration method section 422, an identification number (“1”, “2” or “3”) corresponding to a predetermined restoration method for the role of the virtual machine, of three predetermined restoration methods, is stored. In this case, the restoration method with the identification number “1” (hereinafter referred to as a first restoration method) is a method in which restoration processing is not executed because there is no change in the state of the virtual machine 500. Also, the restoration method with the identification number “2” (hereinafter referred to as a second restoration method) is a method in which the content of change to a file is recorded, and at the time of executing restoration processing, the virtual machine 500 is restored to the state at a predetermined time point (the time point when the virtual machine system is constructed) based on the recorded content of change. Moreover, the restoration method with the identification number “3” (hereinafter referred to a third restoration method) is a method in which the virtual machine 500 as a target of restoration is duplicated and the virtual machine 500 as the target of restoration is replaced with the duplicated virtual machine 500.

Also, in the changed file size threshold section 423, a threshold value used to determine whether the restoration method should be switched to another restoration method or not, based on the total file size of all the files that are changed (hereinafter referred to as a changed file size threshold) is stored. As will be described later, if the total file size of all the files that are changed is larger than this changed file size threshold, the restoration method by which to restore virtual machine 500 is switched from the default restoration method stored in the role-specific setting information management table 420 to another restoration method.

In the restoration time threshold section 424, a threshold value used to determine whether the restoration method in the subsequent restorations should be switched to another restoration method or not, based on the time required to restore the virtual machine 500 of the corresponding role (hereinafter referred to as a restoration time threshold) is housed. As will be described later, if the time required to restore the virtual machine 500 of the corresponding role is greater than this restoration time threshold, the restoration method for subsequent restorations of the virtual machine of that role is switched from the default restoration method stored in the role-specific setting information management table 420 to another restoration method.

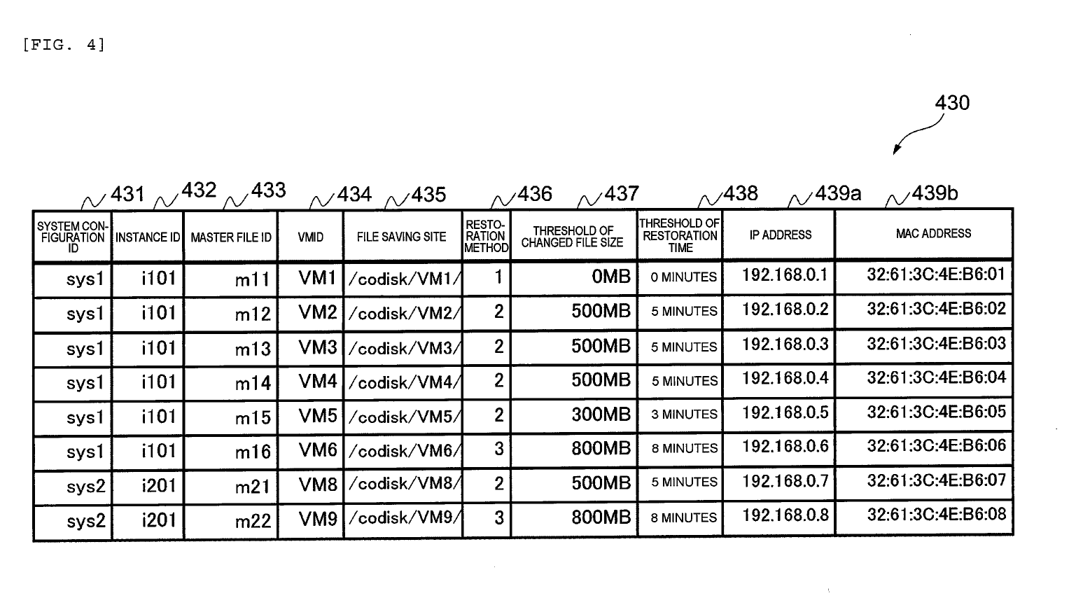

The virtual machine configuration information management table 430 is a table to manage the virtual machine system created in the computer system 1 and the individual virtual machines 500 constituting the virtual machine system, and includes a system configuration ID section 431, an instance ID section 432, a master file ID section 433, a virtual machine ID section 434, a file saving site section 435, a restoration method section 436, a changed file size threshold section 437, a restoration time threshold section 438, an IP address section 439a and a MAC address section 439b, as shown in FIG. 4.

Then, in the system configuration ID section 431, a unique identifier given to the corresponding virtual machine system created in the computer system 1 (hereinafter referred to as a virtual machine system ID) is stored. Also, in the instance ID section 432, an instance ID given to the corresponding virtual machine system is stored. The instance ID is an identifier created by the system saving program 121 when the user instructs the system management portal server 100 to construct the virtual machine system via the client 200.

Moreover, in the master file ID section 433, an identifier given to the master file of the virtual machine image file of the corresponding virtual machine 500 (hereinafter referred to as a master file ID) is stored. In the virtual machine ID section 434, an identifier that is unique to the virtual machine 500 given to the corresponding virtual machine 500 (hereinafter referred to as a virtual machine ID) is stored. Also, in the file saving site section 435, path information representing a path to the storage site of the virtual machine image file of the corresponding virtual machine 500, in the storage unit 400, is stored.

Moreover, in restoration method section 436, the identification number of a restoration method to be applied when restoring the virtual machine 500 to the state at the predetermined time point is stored. In the changed file size threshold section 437 and the restoration time threshold section 438, the above changed file size threshold and restoration time threshold that are defined for the virtual machine 500 are stored respectively.

Furthermore, in the IP address section 439a, an IP address that is set for the virtual machine 500 is stored. In the MAC (Media Access Control) address section 439b, a MAC address that is set for the virtual machine 500 is stored.

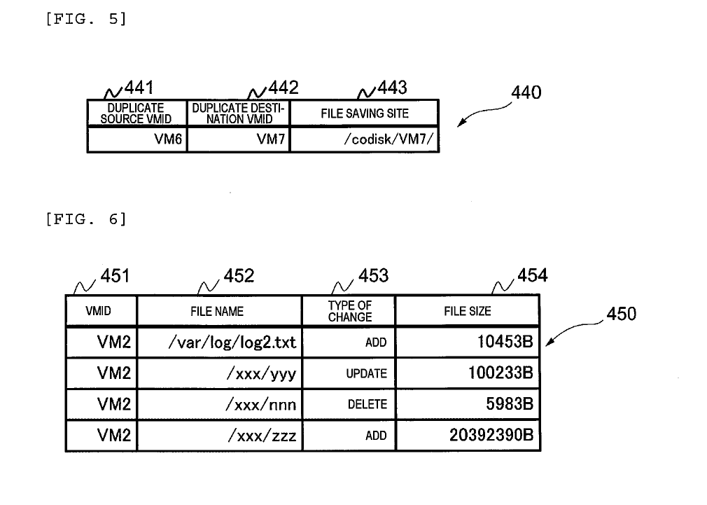

The duplicate virtual machine correspondence information management table 440 is a table to manage a duplicate destination of the virtual machine 500, with respect to the virtual machine 500 for which the third restoration method is prescribed as the restoration method in the virtual machine configuration information management table 430. This duplicate virtual machine correspondence information management table 440 includes a duplicate source virtual machine ID section 441, a duplicate destination virtual machine ID section 442 and a file saving site section 443, as shown in FIG. 5.

Then, in the duplicate source virtual machine ID section 441, the virtual machine ID of the virtual machine 500 for which the third restoration method is prescribed as the restoration method in the virtual machine configuration information management table 430 is stored. In the duplicate destination virtual machine ID section 442, the virtual machine ID of the virtual machine 500 as a duplicate destination of that virtual machine 500 is stored. Also, in the file saving site section 443, path information representing a path to the storage site of the virtual machine image file of the virtual machine 500 as the duplicate destination stored in the storage unit 400 is stored.

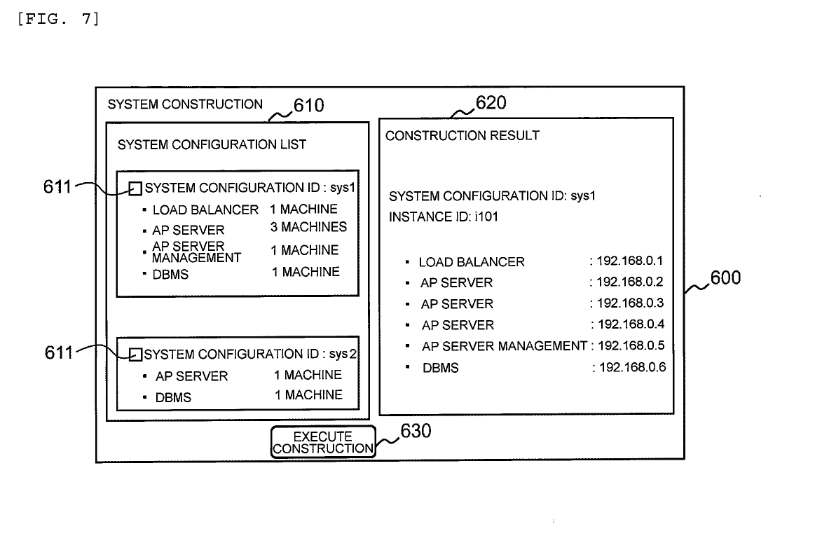

The change content record information management table 450 is a table to manage the content of change made to the virtual machine 500 after the predetermined time point in the corresponding virtual machine system (the time point of system construction), and includes a virtual machine ID section 451, a file name section 452, a change type section 453 and a file size section 454, as shown in FIG. 6.

In the virtual machine ID section 451, the virtual machine ID of the virtual machine 500 in which a file is updated after the corresponding virtual machine system is constructed is stored. In the file name section 452, the file name of the file updated in the virtual machine 500 is stored. Also, in the change type section 453, the content of change to the corresponding file as of the time point of the system construction (“add”, “update”, “delete” or “name change”) is stored. In the file size section 454, the file size of the corresponding file is stored.

Also, in the change content record information management table 450, only one record is registered for each file to which a change is made. Therefore, if a certain file is changed and therefore the content of change is registered in the change content record information management table 450 and then the file is further changed afterwards, a new record corresponding to the latter change is not created and the content of the already existing record corresponding to the file is updated.

### (3) Configurations of System Construction Screen and System Restoration Screen

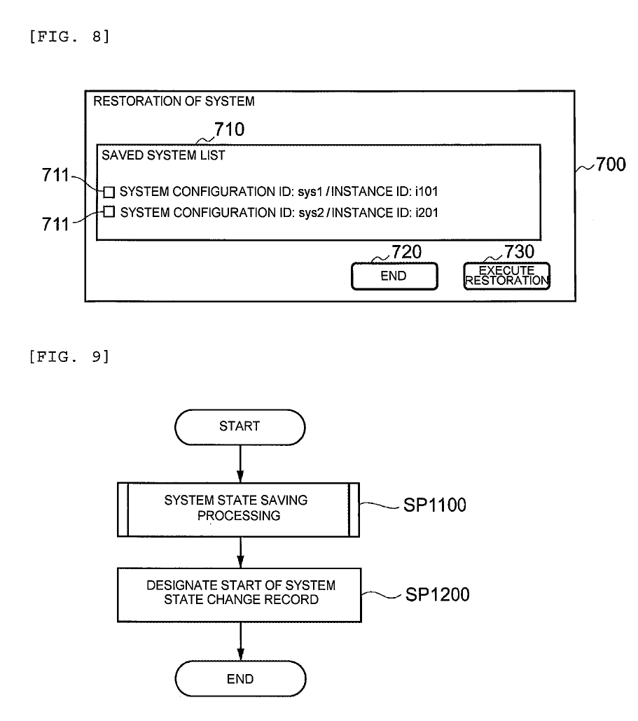

FIG. 7 shows the screen configuration of a system construction screen 600 that can be displayed on the output device 260 of the client 200 as the user operates the client 200. The user can construct a new virtual machine system on the host server 300, using this system construction screen 600.

In practice, a system configuration list display area 610, a construction result display area 620 and a construction execution button 630 are provided on the system construction screen 600. Then, in the system configuration list display area 610, a list of system configurations of one or virtual machine systems that can be constructed at the time is displayed.

For example, in the example of FIG. 7, it is shown that a virtual machine system formed by one load balancer, three application servers, one application server management server and one database management server and having a system configuration ID “sys1”, and a virtual machine system formed by one application server and one database management server and having a system configuration ID “sys2” can be constructed.

Also, in the system configuration list display area 610, a check box 611 is displayed corresponding to each virtual machine system with the system configuration thereof displayed.

Thus, by causing a check mark to be displayed in the check box 611 corresponding to a desired virtual machine system from among the virtual machine systems with the system configuration thereof displayed in the system configuration list display area 610, the user can select that virtual machine system as a target of construction. After that, by clicking on the construction execution button 630, the user can cause the virtual machine system to be constructed on the host server 300.

In practice, when the construction execution button 630 is clicked on, a system construction command to instruct the construction of the virtual machine system selected by the user is transmitted to the system management portal server 100 from the browser 221 of the client 200. In accordance with this system construction command, each virtual machine 500 constituting the virtual machine system is constructed on the host server 300 under the control of the system saving program 121 of the system management portal server 100.

Also, on the system construction screen 600, configuration information about the new virtual machine system that is constructed at this time is displayed in the construction result display area 620. In practice, in the construction result display area 620, the system configuration ID of the virtual machine system that is constructed at this time and the instance ID of the virtual machine system are displayed, and the IP address of each virtual machine 500 constituting the virtual machine system is displayed.

For example, in the example of FIG. 7, the virtual machine system that is constructed at this time has a system configuration ID “sys1” and an instance ID “i101”. The IP address of the virtual machine 500 functioning as a load balancer is “192.168.0.1”. The IP addresses of the three virtual machines 500 functioning as an application server are “192.168.0.2”, “192.168.0.3” and “192.168.0.4”, respectively. The IP address of the virtual machine 500 functioning as an application server management server is “192.168.0.5”. The IP address of the virtual machine 500 functioning as a database management server is “192.168.0.6”.

Meanwhile, FIG. 8 shows the screen configuration of a system restoration screen 700 that can be displayed on the output device 260 of the client 200 as the user operates the client 200. The user can restore a desired virtual machine system from among the existing virtual machine systems to the state at the time of a predetermined time point (the time of system construction), using this system restoration screen 700.

In practice, on the system restoration screen 700, a saved system list display area 710, an end button 720 and a restoration execution button 730 are provided. Then, in the saved system list display area 710, a list of system IDs and instance IDs of all the virtual machine systems having the system configurations thereof saved at the time is displayed.

For example, in the example of FIG. 8, it is shown that the system configurations of a virtual machine system having a system configuration ID “sys1” and an instance ID “i101” and a virtual machine system having a system configuration ID “sys2” and an instance ID “i102” are saved.

Also, in the saved system list display area 710, a check box 711 is displayed corresponding to each virtual machine system having the system configuration ID and the instance ID thereof displayed.

Thus, by causing a check mark to be displayed in the check box 711 corresponding to a desired virtual machine system from among the virtual machine systems having the system configuration ID and the instance ID thereof displayed in the saved system list display area 710, the user can select that virtual machine system as a target of restoration. After that, by clicking on the restoration execution button 720, the user can restore the system configuration of the virtual machine system to the state at the time of system construction.

In practice, when the restoration execution button 720 is clicked on, the a system restoration command to instruct restoration of the virtual machine system selected by the user is transmitted to the system management portal server 100 from the browser 221 of the client 200. In accordance with this system restoration command, the designated virtual machine system is restored to the state at the time of system construction under the control of the system restoration program 121 of the system management portal sever 100.

Also, when the end button 730 on the system restoration screen 700 is clicked on, the restoration of the virtual machine system selected by the user as a target of restoration on the system restoration screen 700 can be canceled.

### (4) Various Kinds of Processing Related to Construction and Restoration of Virtual Machine System

Next, the processing contents of various kinds of processing related to the system saving function and the system restoration function in this computer system 1 will be described. Hereinafter, the processing subject of various kinds of processing is described as a “program” in some cases. However, as a matter of course, the corresponding CPU executes the processing, based on that “program”.

### (4-1) Virtual Machine System Construction Processing

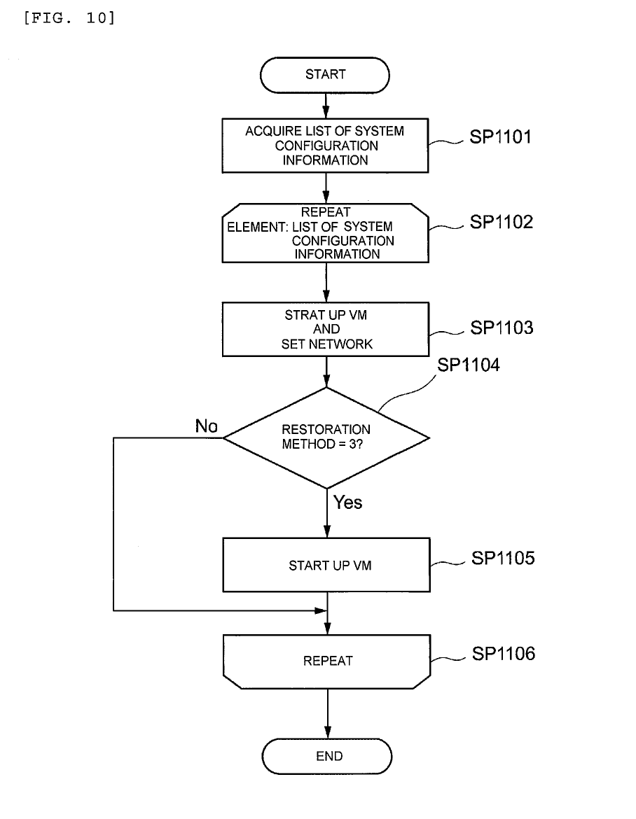

FIG. 9 shows the processing content of the system saving program 121 of the system management portal server 200 related to the system saving function.

When the system saving program 121 receives the above system construction command from the browser 221 (FIG. 1) of the client 200, the system saving program 121 starts the virtual machine system construction processing shown in this FIG. 9 and first saves the current system state of the virtual machine system selected by the user (constructs that virtual machine system) (SP1100).

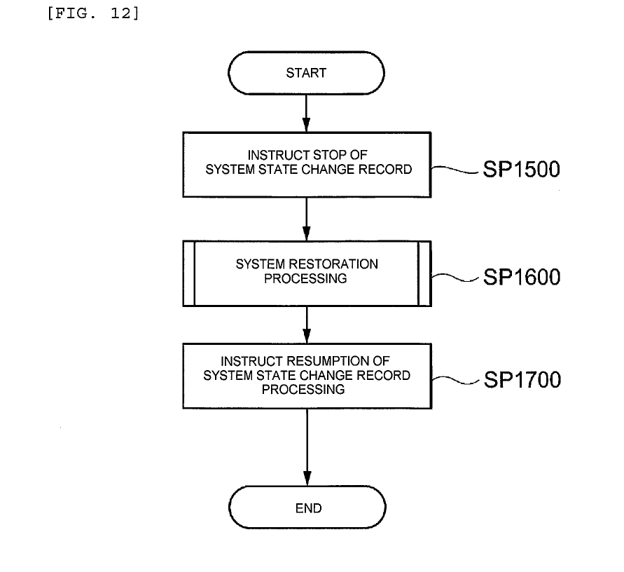

Then, the system saving program 121 gives a command to start change record processing (FIG. 11), later described, to record a change in the system state (hereinafter referred to as a change record start command) to the monitoring agent 502 (FIG. 1) of each virtual machine 500 constituting the virtual machine system constructed in step SP1100. Also, the system saving program 121 notifies the browser 221 of the client 200, of the IP address or the like of each virtual machine 500 constituting the virtual machine system that is constructed at the time (SP1200). Thus, based on this notification, necessary information about the virtual machine system that is constructed at the time is displayed in the construction result display area 620 of the system construction screen 600 described above with reference to FIG. 7.

After that, the system saving program 121 ends this virtual machine system construction and saving processing (SP1300).

### (4-2) System State Saving Processing

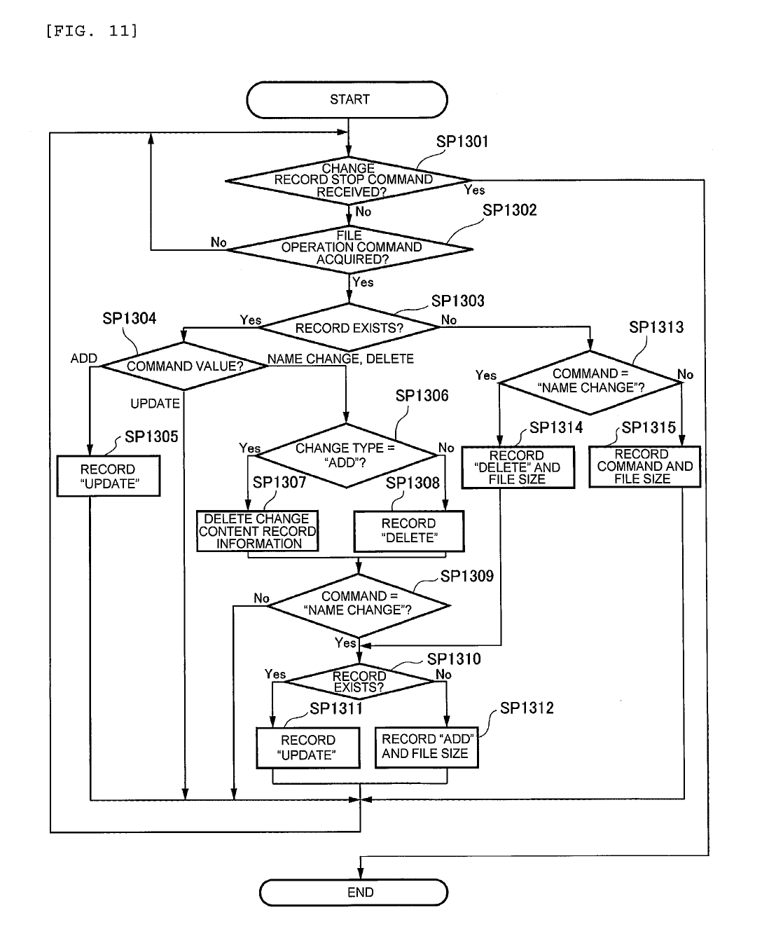

FIG. 10 shows the specific processing content of the system state saving processing executed by the system saving program 121 in step SP1100 of the virtual machine system construction processing (FIG. 9).

As the system saving program 121 advances to step SP1100 of this virtual machine system construction processing, the system saving program 121 starts the system state saving processing shown in this FIG. 10 and first accesses the storage unit 400 via the SAN network 20 and acquires information of a record (line) corresponding to each virtual machine 500 constituting the virtual machine system selected by the user, in the system configuration information management table 410 (FIG. 2) (SP1101).

Then, the system saving program 121 executes processing of step SP1103 to step SP1105 with respect to each record whose information is acquired in step SP1101.

That is, the system saving program 121 creates and starts up a virtual machine 500 corresponding to a record that is taken as the target at the time, and carries out network setting of that virtual machine 500 (SP1103).

Specifically, the system saving program 121 refers to the master file saving site section 414 in the record that is taken as the target at the time, in the system configuration information management table 410 (FIG. 2), and duplicates the virtual machine image file saved at the master file saving site stored in the master file saving site section 414 and saves the duplicate in the storage unit 400. Also, the system saving program 121 starts up the virtual machine 500 based on the saved virtual machine image file. Moreover, the system saving program 121 gives an IP address and a MAC address to the virtual machine 500 and registers necessary information including these addresses, in the virtual machine configuration information management table 430.

Then, the system saving program 121 refers to the role-specific setting information management table 420 and determines whether the restoration method that is preset for the virtual machine 500 created and started up in step SP1103 is the third restoration method or not (SP1104).

If a negative result is obtained in this determination, the system saving program 121 shifts the processing to the next record. On the other hand, if a positive result is obtained in this determination, the system saving program 121 creates a virtual machine 500 that is a duplicate of the virtual machine 500 (SP1105).

Specifically, first, the system saving program 121 refers to the master file saving site section 414 in the record that is taken as the target at the time in the system configuration information management table 410 (FIG. 2), using the identifier of the virtual machine 500 created in step SP1103, and duplicates the virtual machine image file saved at the master file saving site stored in the master file saving site section 414 and saves the duplicate in the storage unit 400. Then, the system saving program 121 adds a new record to the duplicate virtual machine correspondence information management table 440 (FIG. 5), store the identifier of the target virtual machine 500 in the duplicate source virtual machine ID section 441 in that record, stores the identifier of the virtual machine 500 of the duplicate destination in the duplicate destination virtual machine ID section 442, and also stores path information representing a path to the storage site of the virtual machine image file of this duplicate destination virtual machine 500, in the file saving site section 443. The system saving program 121 instructs the virtual machine management program 322 to start up the duplicate destination virtual machine 500 and notifies the monitoring agent 502 of the virtual machine 500, of the identifier of the duplicate destination virtual machine 500.

Then, as the system saving program 121 eventually finishes executing the processing of step SP1103 to step SP1105 with respect to all the records whose information is acquired in step SP1101, the system saving program 121 ends this system state saving processing.

### (4-3) Change Record Processing

Meanwhile, FIG. 11 shows processing procedures of the virtual machine system state change record processing executed by the monitoring agent 502 (FIG. 1) of the host server 300 that receives the change record start command transmitted from the system saving program 121 in step SP1200 of the virtual machine system construction processing described above with reference to FIG. 9.

When the monitoring agent 502 receives this change record start command, the monitoring agent 502 starts this virtual machine system state change record processing and first determines whether a change record stop command, described later, transmitted from the system restoration program 122 is received or not (SP1301).

Then, if a positive result is obtained in this determination, the monitoring agent 502 ends this virtual machine system state change record processing. On the other hand, if a negative result is obtained in the determination of step SP1301, the monitoring agent 502 determines whether a file operation command to change the content of the file of the virtual machine 500 is given from the client 200 or not (SP1302).

If a negative result is obtained in this determination, the monitoring agent 502 returns to step SP1302 and then repeats the loop of step SP1301-step SP1302-step SP1301 until a file operation command is received.

Then, when a file operation command is eventually received, the monitoring agent 502 refers to the change content record information management table 450 and determines whether a record about the file that is the target of this file operation command exists on the change content record information management table 450 or not (SP1303).

If a positive result is obtained in this determination, the monitoring agent 502 determines which of “add”, “update”, “delete” and “name change” is the change operation content designated by this file operation command (SP1304).

Then, if the change operation content designated by this file operation command is “add”, the monitoring agent 502 changes the value in the change type section 453 (FIG. 6) of a record related to a past change operation to the file that is the target of the file operation command, which exists on the change content record information management table 450, to “update” (SP1305).

This is because receiving the file operation command in which the change operation content to that file is “add” despite that the record related to that file exists on the change content record information management table 450 means that the file existing at the time of system construction is deleted later and the file currently does not exist. Therefore, since “adding” the file can be considered to be updating the file in view of the state at the time of system construction, in this case, the value in the change type section 453 (FIG. 6) of the corresponding record on the change content record information management table 450 is changed to “update”. After that, the monitoring agent 502 returns to step SP1301.

Meanwhile, if the change operation content designated by the file operation command is “update”, the monitoring agent 502 returns to step SP1301 without changing the value in the change type section 453 (FIG. 6) of the record related to the file on the change content record information management table 450.

Also, if the change operation content designated by the file operation command is “delete” or “name change”, the monitoring agent 502 determines whether the value in the change type section 453 (FIG. 6) of the record related to the file on the change content record information management table 450 is “add” or not (SP1306).

If a positive result is obtained in this determination, the monitoring agent 502 deletes the record corresponding to the file on the change content record information management table 450 acquired in step SP1303 (SP1307).

This is because the value “add” in the change type section 453 of this record means that the file is added to the virtual machine 500 after the system construction, and “deleting” the file means returning to the state at the time of system construction. Therefore, in this case, the record corresponding to the file on the change content record information management table 450 is deleted, thus treating the file as non-existent from the beginning.

Also, if the change operation content designated by the file operation command is “name change”, the file before the name change is deleted and the file after the name change is treated as newly added. Therefore, also in this case, the record corresponding to the file on the change content record information management table 450 is deleted.

On the other hand, if a negative result is obtained in the determination of step SP1306, the monitoring agent 502 changes the value in the change type section 453 of the record related to the file on the change content record information management table 450 to “delete” (SP1308). This is because the value that is not “add” in the change type section 453 of this record means that the file exists at the time of system construction.

Then, the monitoring agent 502 determines whether the change operation content designated by the file operation command is “name change” or not (SP1309). Then, if a negative result is obtained in this determination, the monitoring agent 502 returns to step SP1301.

On the other hand, if a positive result is obtained in the determination of step SP1309, the monitoring agent 502 refers to the change content record information management table 450 and determines whether a record related to a past change operation to the file that is the target of this file operation command exists on the change content record information management table 450 or not (SP1310).

Here, if the processing advances to step SP1310 via step SP1309, a positive result is necessarily obtained in step SP1310. Thus, in this case, the monitoring agent 502 changes the value in the change type section 453 of the record related to the file on the change content record information management table 450 to “update” (SP1311) and then returns to step SP1301.

Meanwhile, if a negative result is obtained in the determination of step SP1303, the monitoring agent 502 determines whether the change operation content designated by the file operation command is “name change” or not (SP1313).

Then, if a positive result is obtained in this determination, the monitoring agent 502 adds a new record corresponding to the file before the name change, to the change content record information management table 450, and stores “delete” in the change type section 453 (FIG. 6) of that record and stores the file size of the file in the file size section 454 of that record (SP1314). By the way, the reason for storing “delete” in the change type section of this record at this time is because, if the change operation content designated by the file operation command is “name change” as described above, the file before the name change is deleted and the file after the name change is treated as newly added.

Next, the monitoring agent 502 refers to the change content record information management table 450 and determines whether a record related to a past change operation to the file that is the target of this file operation command exists on the change content record information management table 450 or not (SP1310).

Here, if the processing advances to step SP1310 via step SP1314, a negative result is necessarily obtained in step SP1310. Thus, in this case, the monitoring agent 502 adds a new record corresponding to the file after the name change, to the change content record information management table 450, and stores “add” in the change type section 453 (FIG. 6) of that record and stores the file size of the file in the file size section 454 of that record (SP1312). After that, the monitoring agent 502 returns to step SP1301.

Meanwhile, if a negative result is obtained in the determination of step SP1312, the monitoring agent 502 adds a new record corresponding to the file to the change content record information management table 450, and stores the change operation content (“add”, “change” or “delete”) designated by this file operation command in the change type section 453 (FIG. 6) of the record and stores the file size of the file in the file size section 454 of that record (SP1315). After that, the monitoring agent 502 returns to step SP1301.

### (4-4) Virtual Machine System Restoration Processing

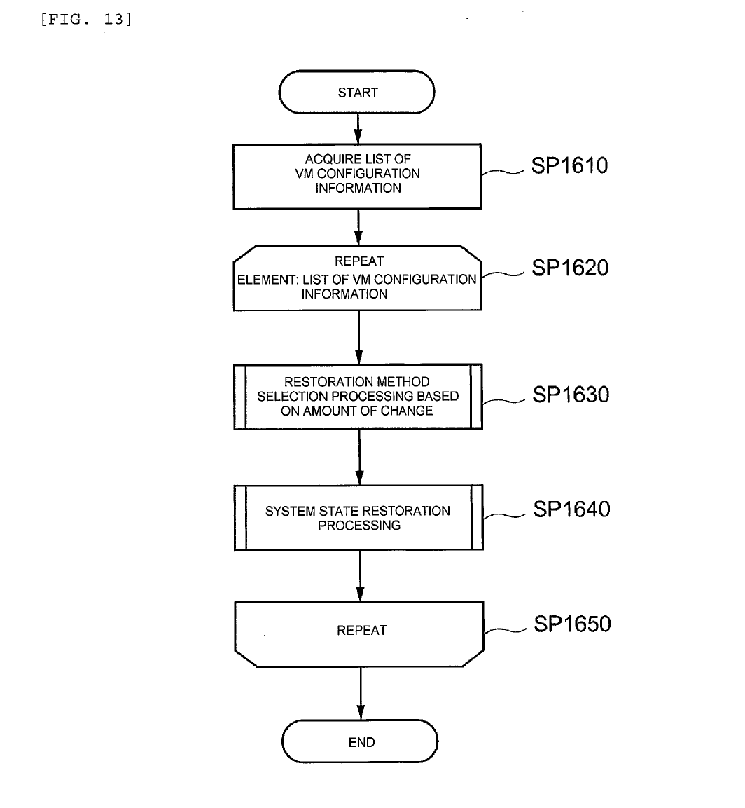

FIG. 12 shows processing contents of the system restoration program 122 of the system management portal server 100 related to the restoration of the system state of the virtual machine system.

When the system restoration program 122 receives the above system restoration command transmitted from the browser 221 of the client 200, the system restoration program 122 starts the virtual machine system restoration processing shown in this FIG. 12 and first transmits the change record stop command described above with reference to step SP1301 of FIG. 11 to the monitoring agent 502 of each virtual machine 500 constituting the virtual machine system that is the target of restoration designated by the system restoration command (SP1500).

Then, the system restoration program 122 instructs the virtual machine management program 322 (FIG. 1) of the corresponding host server 300 to restore the state of each virtual machine 500 constituting the virtual machine system that is the target of restoration designated by the system restoration command, to the state at the time of system construction (SP1600).

Then, when the restoration of all the virtual machines 500 constituting this virtual machine system is finished, the system restoration program 122 instructs the monitoring agents 502502 of these virtual machines 500 to resume the change content record processing described above with reference to FIG. 11 (SP1700) and then ends this virtual machine system restoration processing.

### (4-5) System Restoration Processing

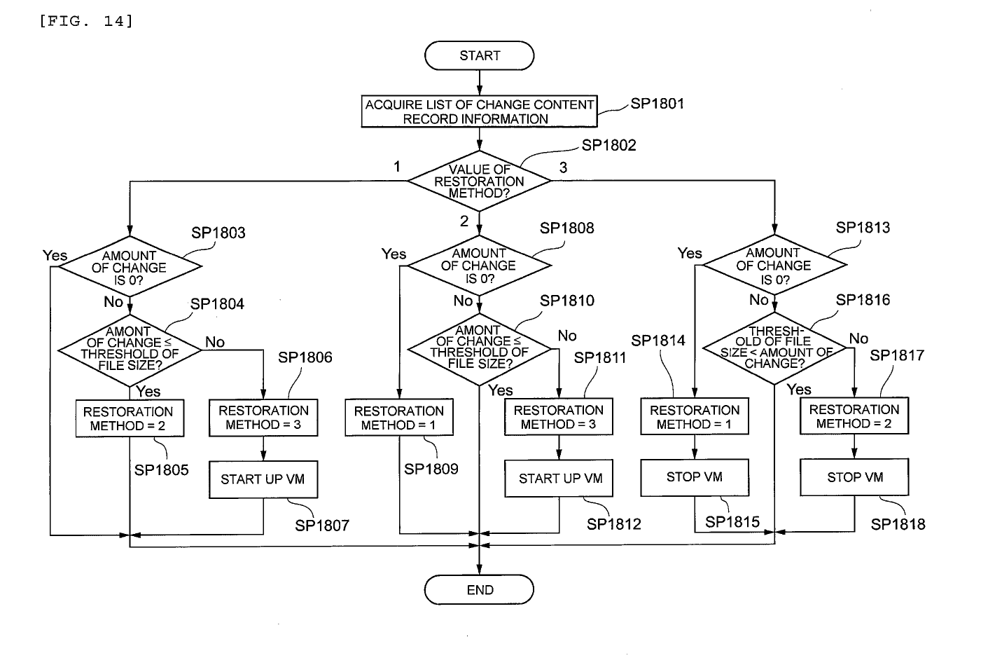

FIG. 13 shows specific processing contents of the system restoration processing executed by the system restoration program 122 in step SP1600 of the virtual machine system restoration processing (FIG. 12).

As the system restoration program 122 advances to step SP1600 of this virtual machine system restoration processing, the system restoration program 122 starts the system restoration processing shown in this FIG. 13, and first accesses the storage unit 400 via the SAN network 20 and acquires information of the record (line) corresponding to each virtual machine constituting the virtual machine system selected by the user, in the system configuration information management table 410 (FIG. 2) (SP1610).

Then, the system restoration program 122 executes the processing of step SP1620 to step SP1650 with respect to each record whose information is acquired in step SP1610.

That is, the system restoration program 122 accesses the storage unit 400 via the SAN network 20, calculates the total file size of all the files that are related to the virtual machine 500 corresponding to the target record at the time and that are registered in the update content record information management table 450, and selects a restoration method for this virtual machine 500 based on the total file size (SP1630).

Next, the system restoration program 122 restores the virtual machine 500 corresponding to the target record at the time, using the restoration method selected in step SP1630 (SP1640).

Then, as the system restoration program 122 finishes executing the processing of step SP1630 and step SP1640 with respect to all the records whose information is acquired in step SP1610, the system restoration program 122 ends this system restoration processing.

### (4-6) Restoration Method Selection Processing

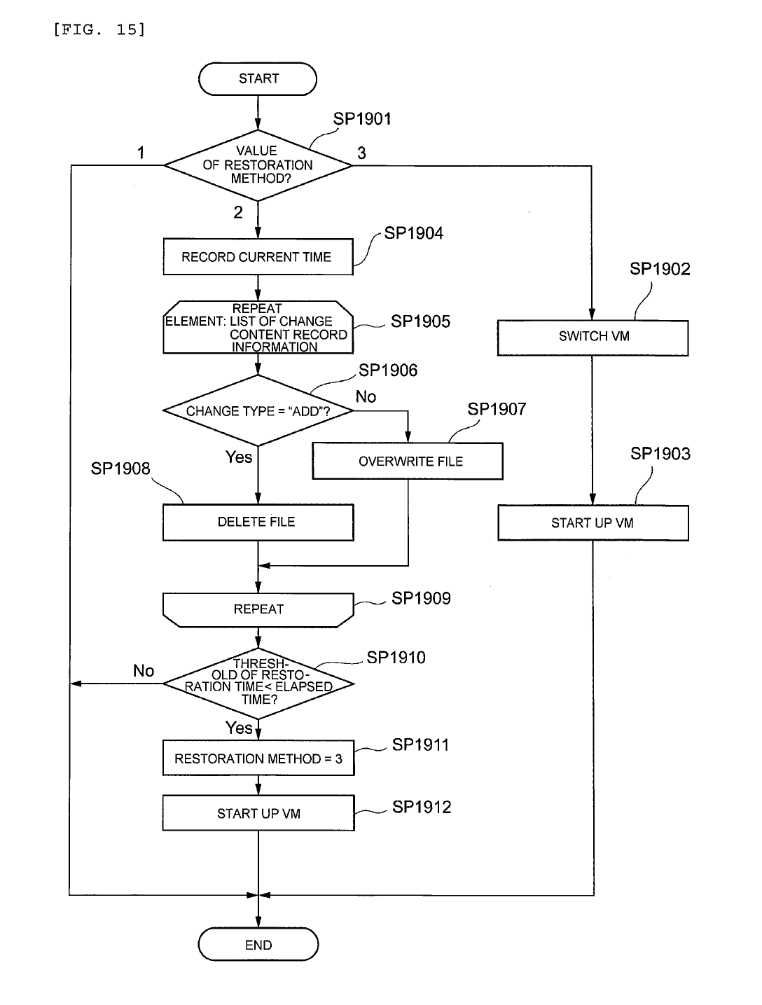

FIG. 14 shows specific processing contents of the restoration method selection processing executed by the system restoration program 122 in step SP1630 of the system restoration processing (FIG. 13).

As the system restoration program 122 advances to step SP1630 of the virtual machine system restoration processing, the system restoration program 122 starts the restoration method selection processing shown in this FIG. 14 and first acquires information of all the records in which the virtual machine ID of the virtual machine 500 that is the target at the time (hereinafter referred to as a target virtual machine) is stored in the virtual machine ID section 451 (FIG. 6), in the change content record information management table 450 (SP1801).

Then, the system restoration program 122 determines which of “1” to “3” is the identification number of the restoration method stored in the restoration method section 436 of the record corresponding to the target virtual machine 500, in the virtual machine configuration information management table 430 (FIG. 4) (SP1802).

Then, if this identification number is determined as “1” in step SP1802, the system restoration program 122 determines whether the total file size of files to which a change is made, of all the files related to the target virtual machine 500, is “0” or not, based on the information acquired in step SP1801 (SP1803).

If a positive result is obtained in this determination, the system restoration program 122 selects the first restoration method as the restoration method for the target virtual machine 500 and then ends this restoration method selection processing.

On the other hand, if a negative result is obtained in the determination of step SP1803, the system restoration program 122 refers to the virtual machine configuration information management table 430 (FIG. 4) and determines whether the total file size of the files to which a change is made, of all the files related to the target virtual machine 500, is equal to or smaller than a changed file size threshold prescribed for that target virtual machine 500, or not (SP1804).

If a positive result is obtained in this determination, the system restoration program 122 selects the first restoration method as the restoration method for the target virtual machine 500 (SP1805) and then ends this restoration method selection processing.

On the other hand, if a negative result is obtained in the determination of step SP1804, the system restoration program 122 selects the third restoration method as the restoration method for the target virtual machine 500 (SP1806).

After that, in order to start up the virtual machine 500 that is the duplicate destination of the target virtual machine 500, the system restoration program 122 adds a new record to the duplicate virtual machine correspondence information management table 440 (FIG. 5), stores the identifier of the target virtual machine 500 in the duplicate source virtual machine ID section 441 of that record, stores the identifier of the virtual machine 500 of the duplicate destination in the duplicate destination virtual machine ID section 442, and also stores path information representing a path to the storage site of the virtual machine image file of this duplicate destination virtual machine 500, in the file saving site section 443. The system restoration program 122 instructs the virtual machine management program 322 to start up the duplicate destination virtual machine 500 and notifies the monitoring agent 502 of the virtual machine 500, of the identifier of the duplicate destination virtual machine 500 (SP1807). After that, the system restoration program 122 ends this restoration method selection processing.

Meanwhile, if the identification number is determined as “2” in step SP1802, the system restoration program 122 determines whether the total file size of files to which a change is made, of all the files related to the target virtual machine 500, is “0” or not, based on the information acquired in step SP1801 (SP1808).

If a positive result is obtained in this determination, the system restoration program 122 selects the first restoration method as the restoration method for the target virtual machine 500 (SP1809) and then ends this restoration method selection processing.

On the other hand, if a negative result is obtained in the determination of step SP1809, the system restoration program 122 refers to the virtual machine configuration information management table 430 (FIG. 4) and determines whether the total file size of the files to which a change is made, of all the files related to the target virtual machine 500, is equal to or smaller than the changed file size threshold prescribed for the target virtual machine 500, or not (SP1810).

If a positive result is obtained in this determination, the system restoration program 122 selects the second restoration method as the restoration method for the target virtual machine 500 and then ends this restoration method selection processing.

On the other hand, if a negative result is obtained in the determination of step SP1810, the system restoration program 122 selects the third restoration method as the restoration method for the target virtual machine 500 (SP1811).

After that, in order to start up the virtual machine 500 that is the duplicate destination when trouble occurs in the target virtual machine 500, the system restoration program 122 adds a new record to the duplicate virtual machine correspondence information management table 440 (FIG. 5), stores the identifier of the target virtual machine 500 in the duplicate source virtual machine ID section 441 of that record, stores the identifier of the virtual machine 500 of the duplicate destination in the duplicate destination virtual machine ID section 442, and also stores path information representing a path to the storage site of the virtual machine image file of this duplicate destination virtual machine 500, in the file saving site section 443. The system restoration program 122 instructs the virtual machine management program 322 to start up the duplicate destination virtual machine 500 and notifies the monitoring agent 502 of the virtual machine 500, of the identifier of the duplicate destination virtual machine 500 (SP1812). After that, the system restoration program 122 ends this restoration method selection processing.

Meanwhile, if the identification number is determined as “3” in step SP1802, the system restoration program 122 determines whether the total file size of files to which a change is made, of all the files related to the target virtual machine 500, is “0” or not, based on the information acquired in step SP1801 (SP1813).

If a positive result is obtained in this determination, the system restoration program 122 selects the first restoration method as the restoration method for the target virtual machine 500 (SP1814).

Then, the system restoration program 122 instructs the virtual machine management program 322 (FIG. 1) to stop the target virtual machine 500 and also deletes the virtual machine ID stored in the duplicate destination virtual machine ID section 442 of the record corresponding to the target virtual machine 500 in the duplicate virtual machine correspondence information management table 440 (FIG. 5) and the virtual machine image file saved in the file saving site stored in the file saving site section 443 of the record. The system restoration program 122 also deletes the record from the duplicate virtual machine correspondence information management table 440 (SP1815). After that, the system restoration program 122 ends this restoration method selection processing.

On the other hand, if a negative result is obtained in the determination of step SP1813, the system restoration program 122 refers to the virtual machine configuration information management table 430 (FIG. 4) and determines whether the total file size of the files to which a change is made, of all the files related to the target virtual machine 500, is equal to or greater than the changed file size threshold prescribed for the target virtual machine 500, or not (SP1816).

If a positive result is obtained in this determination, the system restoration program 122 selects the third restoration method as the restoration method for the target virtual machine 500 and then ends this restoration method selection processing.

On the other hand, if a negative result is obtained in the determination of step SP1816, the system restoration program 122 selects the second restoration method as the restoration method for the target virtual machine 500 (SP1817).

Then, the system restoration program 122 instructs the virtual machine management program 322 (FIG. 1) of the corresponding host server 300 to stop the target virtual machine 500 and also deletes the virtual machine ID stored in the duplicate destination virtual machine ID section 442 of the record corresponding to the target virtual machine 500 in the duplicate virtual machine correspondence information management table 440 (FIG. 5) and the virtual machine image file saved in the file saving site stored in the file saving site section 443 of the record. The system restoration program 122 also deletes the record from the duplicate virtual machine correspondence information management table 440 (SP1818). After that, the system restoration program 122 ends this restoration method selection processing.

### (4-7) System State Restoration Processing

FIG. 15 shows specific processing contents of the system state restoration processing executed by the system restoration program 122 in step SP1640 of the system restoration processing (FIG. 13).

As the system restoration program 122 advances to step SP1640 of the virtual machine system restoration processing, the system restoration program 122 starts the system state restoration processing shown in this FIG. 15 and first determines which of the first to third restoration methods is the restoration method for the target virtual machine 500 selected in the above restoration method selection processing (SP1901).

Then, if the restoration method for the target virtual machine 500 selected in the restoration method selection processing is the first restoration method, the system restoration program 122 ends this system state restoration processing without restoring the target virtual machine 500.

Meanwhile, if the restoration method for the target virtual machine 500 selected in the restoration method selection processing is the third restoration method, the system restoration program 122 switches the target virtual machine 500 to the corresponding duplicate destination virtual machine 500 registered in the duplicate virtual machine correspondence information management table 440 (FIG. 5) (SP1902).

Specifically, the system restoration program 122 gives an instruction that the target virtual machine 500 should be stopped, to the virtual machine management program 322 of the corresponding host server 300. Then, the system restoration program 122 deletes the virtual machine image file saved at the site shown in the file saving site section 435 of the virtual machine configuration table 430 (FIG. 4). Also, the system restoration program 122 acquires the information of the record of the target virtual machine 500 in the duplicate virtual machine correspondence table 440 and instructs the virtual machine management program 332 to set record information of the target virtual machine 500 in the IP address section 439a and the MAC address section 439b of the virtual machine configuration table 430 of the duplicate destination virtual machine ID 442. Moreover, the system restoration program 122 records the record information of the duplicate destination virtual machine 500 in the virtual machine configuration table 430 (FIG. 4). Finally, the system restoration program 122 deletes the record information of the target virtual machine 500 in the virtual machine configuration table 430 and the corresponding record information in the duplicate virtual machine correspondence table 440.

Then, the system restoration program 122 refers to the duplicate virtual machine correspondence information management table 440, confirms the virtual machine 500 having the identifier thereof registered in the duplicate virtual machine correspondence information management table 440 as the duplicate destination of the target virtual machine 500, and instructs the virtual machine management program 322 of the corresponding host server 300 to start up that virtual machine 500. Moreover, the system restoration program 122 notifies the monitoring agent 502 of the virtual machine 500, of the identifier of the duplicate destination virtual machine 500 (SP1903). After that, the system restoration program 122 ends this system state restoration processing.

On the other hand, if the restoration method for the target virtual machine 500 selected in the restoration method selection processing is the second restoration method, the system restoration program 122 records the current time (SP1904). After that, the system restoration program 122 executes the processing of step SP1905 to step SP1909 with respect to each record on the change content record information management table 450 (FIG. 6) corresponding to the target virtual machine 500.

That is, the system restoration program 122 determines whether the value stored in the change type section 453 of the record that is the target at the time on the change content record information management table 450 is “add” or not (SP1906).

Then, if a negative result is obtained in this determination, the system restoration program 122 overwrites the virtual machine image file of the target virtual machine 500 with the master file (SP1907).

On the other hand, if a positive result is obtained in the determination of step SP1906, the system restoration program 122 deletes the virtual machine image file of the target virtual machine 500 from the storage unit 400 (SP1909).

Then, when the system restoration program 122 completes the processing of step SP1905 to step SP1909 with respect to each record on the change content record information management table 450 (FIG. 6) corresponding to the target virtual machine 500 and thus finishes restoring all the files to which a change is made, in the target virtual machine 500, to the state at the time of system construction, the system restoration program 122 goes to step SP1910.

Then, in step SP1910, the system restoration program 122 calculates the elapsed time from the time recorded in step SP1904 to the current time (that is, the time required for restoring the target virtual machine 500, hereinafter referred to as a required restoration time), and determines whether this required restoration time is greater than the restoration time threshold 438 prescribed for this target virtual machine 500 or not, referring to the virtual machine configuration information management table 430 (FIG. 4) (SP1910).

If a negative result is obtained in this determination, the system restoration program 122 ends this system state restoration processing. Meanwhile, if a positive result is obtained in the determination of step SP1910, the system restoration program 122 sets the third restoration method as the restoration method for the target virtual machine 500. By the way, this setting is carried out by changing the identification number in the restoration method section 436 of the record corresponding to the virtual machine configuration information management table 430 to “3”.

Moreover, the system restoration program 122 instructs the virtual machine management program 322 (FIG. 1) of the corresponding host server 300 to start up a new virtual machine for duplicating the virtual machine in another virtual machine, and also notifies the monitoring agent 502 of the virtual machine 500, of the identifier of the duplicate destination virtual machine 500 (SP1912). After that, the system restoration program 122 ends this system state restoration processing.

(4-8) Advantages of this Embodiment

As described above, in the computer system 1 according to this embodiment, with respect to the virtual machine system constructed with one or plural virtual machines 500 provided by the host server 300, the content of change in the state from the time point of construction of the virtual machine system is recorded for each virtual machine 500 in the change content record information management table 450 (FIG. 6). At the time of restoration, an optimum restoration method is selected for each virtual machine 500 from among plural restoration methods, based on the total file size of changed files, and the virtual machine 500 is restored by the selected restoration method. Therefore, an appropriate restoration method corresponding to the content of change can be selected for each virtual machine 500. Thus, the system state of the virtual machine system can be restored efficiently.

### (5) Other Embodiments

In the above embodiment, the case where the states of all the virtual machines 500 constituting the virtual machine system are restored to the time point of system construction of the virtual machine system, at the time of the restoration processing of the virtual machine system, is described. However, the invention is not limited to this. It is also possible to restore only a virtual machine 500 that needs to be restored, such as a virtual machine 500 in which trouble is occurring, to the state at the time point of system construction.

Also, in the above embodiment, the case where the time point at which the state of the virtual machine system is restored is the time point of system construction of the virtual machine system is described. However, the invention is not limited to this. For example, a part or the whole of the information stored in the change content record information management table 450 can be erased at a desired time point by a user's operation. Thus, the time point at which the virtual machine system is restored can be another time point than the time point of system construction.

Also, in the above embodiment, the virtual machine system made up of plural virtual machines is described as an example. However, the invention is not limited to this. For example, a virtual machine system may have a configuration including one or plural physical computers or a mixture of one or plural virtual machines and physical computers.

Also, in the above embodiment, the system management portal server 100 is described using the example in which the system management server 100 is physically separated from the host servers 300a and 300b. However, the invention may include a configuration in which the system management portal server 100 is provided inside the host server 300a (or b) and can be applied to various configurations without departing from the scope of the invention.

Moreover, in the above embodiment, the example in which various kinds of software or the like are stored in an SSD, hard disk or the like is described. However, of course, these kinds of software can be stored in various portable recording media or various recording media that are attachable to and removable from a computer, and of course, can be downloaded from outside to the system management portal server 100 or the host server 300a or b or the like via a network.

### REFERENCE SIGNS LIST

100 . . . system management portal server
110, 210, 310 . . . CPU
120, 220, 320 . . . memory
121 . . . system saving program
122 . . . system restoration program
200 . . . client
221 . . . browser
300 . . . host server
322 . . . virtual machine management program
400 . . . storage unit
410 . . . system configuration information management table
420 . . . role-specific setting information management table
430 . . . virtual machine configuration information management table
440 . . . duplicate virtual machine correspondence information management table
450 . . . change content record information management table
500 . . . virtual machine
502 . . . monitoring agent
511 . . . load balancer program
512 . . . application server program
513 . . . application server management program
514 . . . database management program

1. A computer system characterized by comprising:
a host server which provides a computer system made up of one or plural computers to a client; and
a management server which instructs the host server to construct the computer system or to restore a system state of the computer system that already exists, in response to a request from a user;
wherein the host server
records a content of change in the state from a predetermined time point for each of the computers, and
for at least one of the computers constituting the computer system, selects an optimum restoration method for the computer from plural restoration methods, based on the recorded content of change in the state from the predetermined time point for each of the computers in response to the instruction from the management server, and restores the state of the computer to the state at the predetermined time point by the restoration method that is selected.

2. The computer system according to claim 1, characterized in that
the host server
records a file size of each file that is changed, as the content of change in the state from the predetermined time point for each of the computers, and
selects a restoration method for restoring the state of the computer to the state at the predetermined time point, based on a total file size of the changed file in the computer.

3. The computer system according to claim 2, characterized in that
the host server
holds a threshold value of the total file size of the changed file, predetermined for each role of the computer in the computer system,
compares the total file size of the changed file in the computer with the threshold value of the total file size corresponding to the role of the computer in the computer system, and
selects a restoration method for restoring the state of the computer to the state at the predetermined time point, based on a result of the comparison.

4. The computer system according to claim 1, characterized in that
the host server
changes the restoration method for restoring the state of the computer to the state at the predetermined time point next time or after, to another restoration method according to need, based on a restoration time that is a time required for restoring the state of the computer to the state at the predetermined time point.

5. The computer system according to claim 4, characterized in that
the host server
holds a threshold value of the restoration time predetermined for each role of the computer in the computer system,
compares time required for restoring the state of the computer to the state at the predetermined time point with the threshold value of the restoration time corresponding to the role of the computer in the computer system, and
changes the restoration method for restoring the state of the computer to the state at the predetermined time point, to another restoration method according to need, based on a result of the comparison.

6. The computer system according to claim 1, characterized in that the predetermined time point is a time of point of construction of the corresponding computer system.

7. The computer system according to claim 1, characterized in that the computer constituting the computer system includes a virtual machine.

8. A management method for a computer system including a host server which provides a computer system made up of one or plural computers to a client, and a management server which instructs the host server to construct the computer system or to restore a system state of the computer system that already exists in response to a request from a user, the method being characterized by comprising:
a first step in which the host server records a content of change in the state from a predetermined time point for each of the computers; and
a second step in which for at least one of the computers constituting the computer system, the host server selects an optimum restoration method for the computer from plural restoration methods, based on the recorded content of change in the state from the predetermined time point for each of the computers in response to the instruction from the management server, and restores the state of the computer to the state at the predetermined time point by the restoration method that is selected.

9. The management method for the computer system according to claim 8, characterized in that
in the second step, the host server
records a file size of each file that is changed, as the content of change in the state from the predetermined time point for each of the computers, and
selects a restoration method for restoring the state of the computer to the state at the predetermined time point, based on a total file size of the changed file in the computer.

10. The management method for the computer system according to claim 9, characterized in that
the host server
holds a threshold value of the total file size of the changed file, predetermined for each role of the computer in the computer system, and
in the second step, the host server
compares the total file size of the changed file in the computer with the threshold value of the total file size corresponding to the role of the computer in the computer system, and
selects a restoration method for restoring the state of the computer to the state at the predetermined time point, based on a result of the comparison.

11. The management method for the computer system according to claim 8, characterized in that
in the second step, the host server
changes the restoration method for restoring the state of the computer to the state at the predetermined time point next time or after, to another restoration method according to need, based on a restoration time that is a time required for restoring the state of the computer to the state at the predetermined time point.

12. The management method for the computer system according to claim 11, characterized in that
the host server
holds a threshold value of the restoration time predetermined for each role of the computer in the computer system, and
in the second step, the host server
compares time required for restoring the state of the computer to the state at the predetermined time point with the threshold value of the restoration time corresponding to the role of the computer in the computer system, and
changes the restoration method for restoring the state of the computer to the state at the predetermined time point, to another restoration method according to need, based on a result of the comparison.

13. The management method for the computer system according to claim 8, characterized in that the predetermined time point is a time of point of construction of the corresponding computer system.

14. The computer system according to claim 8, characterized in that the computer constituting the computer system includes a virtual machine.
